(19) United States
(12) Patent Application Publication
(10) Pub. No.: US 2015/0029342 A1
(43) Pub. Date: Jan. 29, 2015

(54) BROADCASTING PROVIDING APPARATUS, BROADCASTING PROVIDING SYSTEM, AND METHOD OF PROVIDING BROADCASTING THEREOF

(71) Applicant: SAMSUNG ELECTRONICS CO., LTD., Suwon-si (KR)

(72) Inventors: Sang-kyun IM, Seoul (KR); Cheon-seong LEE, Yongin-si (KR)

(73) Assignee: SAMSUNG ELECTRONICS CO., LTD.

(21) Appl. No.: 14/336,328

(22) Filed: Jul. 21, 2014

(30) Foreign Application Priority Data
Jul. 24, 2013 (KR) 10-2013-0087183

(51) Int. Cl. H04N 21/234; H04N 21/4722; H04N 21/2187

(52) U.S. Cl. CPC H04N 21/23418; H04N 21/2187; H04N 21/4722
USPC 348/157

(57) ABSTRACT

A method of providing broadcasting of a broadcasting providing apparatus includes receiving a plurality of images of a broadcasting program from a broadcasting source and information related to an object selected by a user, when information related to the selected is received, detecting at least one image related to the selected object from the plurality of images, and transmitting the at least one detected image to an display apparatus.

### CROSS-REFERENCE TO RELATED APPLICATIONS

This application claims priority benefit from Korean Patent Application No. 10-2013-0087183, filed on Jul. 24, 2013, in the Korean Intellectual Property Office, the disclosure of which is incorporated herein by reference in its entirety.

### BACKGROUND

1. Field

The following description relates to provide a broadcasting providing apparatus, a broadcasting providing system, and a method of providing broadcasting thereof, and more particularly, to provide a broadcasting providing apparatus that tracks an object included in a broadcasting program to provide the object to a user in real time, a broadcasting providing system, and a method of providing broadcasting thereof.

2. Description of the Related Art

A broadcasting producer selects one of a plurality of images that are captured by a plurality of cameras, to provide a broadcasting, which has been currently provided, to a user in real time. In this case, the broadcasting program provides a multi-view image, but an object that a viewer wants to view is not continuously displayed on a screen.

For example, as to a soccer broadcasting program, a viewer wants to continuously view a particular soccer player. However, as a screen is continuously changed, the viewer may not continuously view the particular soccer player. Also, as to a music broadcasting program, the viewer wants to continuously view only a singer. However, as the screen is continuously changed, the viewer may not continuously view only the signer.

Therefore, there is a need for a method of tracking an object that a viewer wants to continuously view and providing the tracked object to the viewer.

### SUMMARY

Exemplary embodiments address at least the above problems and/or disadvantages and other disadvantages not described above. Also, exemplary embodiments are not required to overcome the disadvantages described above, and an exemplary embodiment may not overcome any of the problems described above.

Exemplary embodiments provide a broadcasting providing apparatus that detects at least one of a plurality images of a broadcasting program received from a broadcasting station to generate an image content, wherein the at least one image includes an object selected by a user, a broadcasting providing system, and a method of providing broadcasting thereof.

According to an aspect of exemplary embodiments, there is provided. A method of providing broadcasting of a broadcasting providing apparatus. The method may include: receiving a plurality of images of at least one broadcasting program from a broadcasting source; receiving information related to an object selected by a user, detecting at least one image related to the selected object from the plurality of images based on the received information; generating an image content based on the at least one detected image; and transmitting the generated image content to a display apparatus.

The generating of the image content may include: when the information is received while the plurality of images are received in real time, detecting at least one image related to the selected object from the plurality of images in real time; and generating a live streaming image content by based on the at least one detected image in real time.

When a first image related to the selected object is detected from the plurality of images for a first time section after the information is received, and a second image related to the selected object is detected from the plurality of images for a second time section after the first time section, the live streaming image content may be generated for the first time section by using the first image, and the live streaming image content may be generated for the second time section by using the second image.

When a plurality of images comprises the selected object, an image related to the selected object with an occupying ratio of the object is the largest may be detected from the plurality of images related to the selected object.

When the at least one broadcasting program is a sports broadcasting program, the object may be a sports player included in the sports broadcasting program.

An image including the sports player is detected by using at least one of a face, a uniform, and a player's number of the sports player.

According to another aspect of exemplary embodiments, there is provided a broadcasting providing apparatus including: a communicator to receive a plurality of images of at least one broadcasting program and information related to an object selected by a user and a controller to detect at least one image related to the selected object from the plurality of images, to generate an image content based on the at least one detected image and to transmit the generated image content to a display apparatus

When the information related to the selected object is received while the plurality of images in the at least one broadcasting program is received from a broadcasting source, the controller may detect an image related to the selected object from the plurality of images in real time and generate a live streaming image content by using the images that are detected in real time.

When a first image related to the selected object is detected from the plurality of images for a first time section after the information is received, and a second image related to the selected object is detected from the plurality of images for a second time section after the first time section, the controller may generate the live streaming image content for the first time section by using the first image and generate the live streaming image content for the second time section by using the second image.

When a plurality of images include the selected object, the controller may detect an image related to the selected object with an occupying ratio is the largest, from the plurality of images related to the selected object.

When the broadcasting program is a sports broadcasting program, the object may be a sports player included in the sports broadcasting program.

The controller may detect an image including the sports player by using at least one of a face, a uniform, and a player's number of the sports player.

According to another aspect of exemplary embodiments, there is provided a method of providing broadcasting of a broadcasting providing system. The method may include: receiving a plurality of images in at least one broadcasting program in a broadcasting providing apparatus; information related to an object selected by a user is input, transmitting the information to the broadcasting providing apparatus from a display apparatus; when the object selection command is received, detecting at least one image related to the selected object from the plurality of images in the broadcasting providing apparatus; generating an image content based on the at lest one detected image; transmitting the generated image content from the broadcasting providing apparatus to the display apparatus; and displaying the image content in the display apparatus.

The generating of the image contents may include: when the information related to the selected object is received, detecting at lest one image related to the selected object from the plurality of images in real time in the broadcasting providing apparatus; and generating a live streaming image content based on the at least one detected image received in real time. The transmitting of the image content to the display apparatus may include: transmitting the live streaming image content in real time.

The transmitting the input object selection command to the broadcasting providing apparatus may include: displaying an object selection user interface (UI), which is to select an object, through the display apparatus; and when the object selection command is input through the object selection UI, transmitting the object selection command to the broadcasting providing apparatus.

The transmitted image content may be displayed along with the broadcasting program.

### BRIEF DESCRIPTION OF THE DRAWINGS

The above and/or other aspects will be more apparent by describing certain exemplary embodiments with reference to the accompanying drawings, in which:

FIG. 1 is a view illustrating a broadcasting providing system according to an exemplary embodiment of the present general inventive concept;

FIG. 2 is a block diagram illustrating a structure of a broadcasting providing apparatus according to an exemplary embodiment of the present general inventive concept;

FIG. 3 is a block diagram illustrating a structure of a display apparatus according to an exemplary embodiment of the present general inventive concept;

FIG. 4 is a view illustrating an object selecting user interface (UI) according to an exemplary embodiment of the present general inventive concept;

FIG. 5 is a view illustrating a broadcasting program and an object image according to an exemplary embodiment of the present general inventive concept;

FIG. 6 is a flowchart illustrating a method of providing broadcasting of a broadcasting providing apparatus according to an exemplary embodiment of the present general inventive concept; and

FIG. 7 is a chart illustrating a method of providing a broadcasting of a broadcasting providing system according to an exemplary embodiment of the present general inventive concept.

### DETAILED DESCRIPTION

Exemplary embodiments are described in greater detail with reference to the accompanying drawings.

In the following description, the same drawing reference numerals are used for the same components even in different drawings. The matters defined in the description, such as detailed construction and components, are provided to assist in a comprehensive understanding of exemplary embodiments. Thus, it is apparent that exemplary embodiments may be carried out without those specifically defined matters. Also, well-known functions or constructions are not described in detail since they would obscure exemplary embodiments with unnecessary detail.

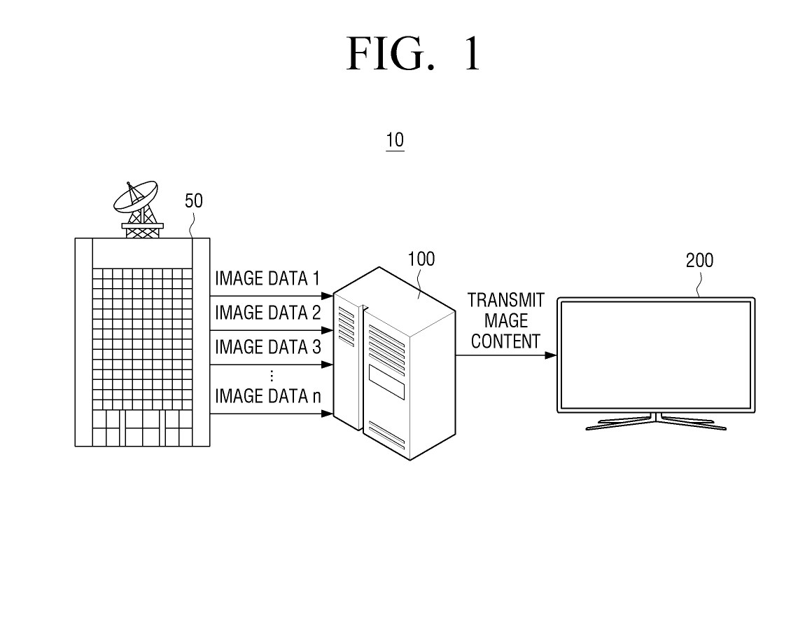

FIG. 1 is a view illustrating a broadcasting providing system 10 according to an exemplary embodiment of the present general inventive concept. The broadcasting providing system 10 may include a broadcasting station 50, a broadcasting providing apparatus 100, and a display apparatus 200. The broadcasting providing apparatus 100 may include, for example, a server, a set-top box or the like. However, the inventive concept is not limited thereto. For example, the broadcasting providing apparatus may be any electronic device capable of providing the broadcasting. The display apparatus 200 may be, for example, a Television (TV), a smart TV, a personal computer (PC) such as a desktop PC, a portable computer, a phone, a smart phone, a tablet PC, or the like. However, the inventive concept is not limited thereto. For example, the display apparatus may be any electronic device capable of displaying the broadcasting.

The broadcasting station 50 generates a plurality of pieces of image data of a broadcasting program. In detail, the broadcasting station 50 may generate a plurality of pieces of image data that are captured by a plurality of cameras, for a broadcasting program. Here, the broadcasting station 50 may provide one selected from the plurality of pieces of image data as a broadcasting image to a user. For example, if a broadcasting program is a sports game, the broadcasting station 50 may select one from the plurality of pieces of image data in real time and provide the selected image data as a broadcasting image to the display apparatus 200.

As shown in FIG. 1, the broadcasting station 50 may transmit the plurality of pieces of image data (1 to n) to the broadcasting providing apparatus 100.

The broadcasting providing apparatus 100 may edit the plurality of pieces of image data according to a request of the user to generate an image content and transmit the generated image content to the user.

In detail, if an object selection command is received from the display apparatus 200 through an input of the user, the broadcasting providing apparatus 100 may extract image data including an object selected by the user from the plurality of pieces of image data. For example, the broadcasting proving apparatus 100 may detect a selected object from first image of a plurality of images for a first time section after the object selection command is received and detect a selected object from second image of the plurality of images for a second time section. The broadcasting providing apparatus 100 may also generate an image content by using image data including an object and transmit the generated image content to the display apparatus 200. Here, the broadcasting providing apparatus 100 may generate a live streaming image content by using image data including an object and stream the generated image content.

The display apparatus 200 may display the image content received from the broadcasting providing apparatus 100. Here, the image content received from the broadcasting providing apparatus 100 may be an image content that includes images including an object selected by the user. The display apparatus 200 may also display the image content received from the broadcasting providing apparatus 100 and the broadcasting image received from the broadcasting station 50.

Through the broadcasting providing system 10 as described above, the user may continuously view a broadcasting program and an object that the user wants to view.

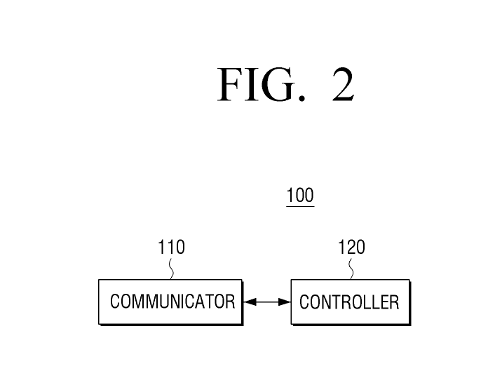

The broadcasting providing apparatus 100 will now be described in more detail with reference to FIG. 2. As shown in FIG. 2, the broadcasting providing apparatus 100 includes a communicator 110 and a controller 120.

The communicator 110 communicates with an external apparatus. The communicator 110 may communicate with the external apparatus using various types of a wired and/or wireless communication method, for example, WiFi, Institute of Electrical and Electronics Engineers (IEEE), Zigbee, 3rd Generation (3G), 3rd Generation Partnership Project (3GPP), Long Term Evolution (LTE), and etc. The communicator 110 may include at least one communication chip to perform the wired and/or wireless communication method. Further, a single chip capable of performing at least one of the wired and wireless communication methods may be included in the communicator 100. For example, when the communication 100 includes the WiFi chip, the communicator 110 may transmit and receive various types of connection information such as subsystem identification (SSID) and a session key, and perform a communication connection by using the various types of connection information to transmit and receive various types of information. The wireless communication chip refers to a chip that perform communication according to various types of communication standards such as Institute of Electrical and Electronics Engineers (IEEE), Zigbee, 3rd Generation (3G), 3rd Generation Partnership Project (3GPP), Long Term Evolution (LTE), and etc.. However, the inventive concept is not limited thereto. Any communication method capable of performing the communication with the communicator 100 may be used.

In particular, the communicator 110 may communicate with various types of apparatuses such as the broadcasting station 50, the display apparatus 200, etc. Here, the communicator may communicate with the broadcasting station 50 or the display apparatus 200 by using an Internet Protocol (IP) network, for example, but this is only an exemplary embodiment. Therefore, the communicator 110 may communicate with the broadcasting station 50 or the display apparatus 200 by using various types of communication methods capable of performing the communication.

The communicator 110 may receive a plurality of pieces of image data of a broadcasting program from the broadcasting station 50. In detail, the communicator 110 may receive first, second, . . . , and N^{th} image data from the broadcasting station 50. The first image data is acquired by capturing a broadcasting program through a first camera, the second image data is acquired by capturing the broadcasting program through a second camera, and the N^{th} image data is acquired by capturing the broadcasting program through an N^{th} camera.

The communicator 110 may transmit an image content including an object selected by the user to the display apparatus 200. Here, the communicator 110 may stream the image content to the display apparatus 200 in real time.

The controller 120 may control an overall operation of the broadcasting providing apparatus 100. In particular, if an object selection command is received from the display apparatus 200 when a plurality of pieces of image data of a broadcasting program are received through the communicator 110, the controller 120 may control the communicator 110 to detect an image including a selected object from a plurality of images received to generate an image content and transmit the generated image content to the display apparatus 200.

In detail, if the object selection command is received from the display apparatus 200 when a plurality of pieces of image data of a broadcasting program are received from the broadcasting station 50 in real time, the controller 120 may detect an image including a selected object from a plurality of images in real time and generate a live streaming image content by using the detected images. For example, if the a broadcasting program is a soccer game, an object may be a soccer player who plays a soccer game. In other words, if an object selection command to select soccer player A is received from the display apparatus 200, the controller 120 may detect an image including the selected soccer player A from a plurality of images of the soccer game. Here, the controller 120 may detect at least one of a face, a uniform, a player's number, or any unique feature of a sports player to detect an image including the sports player selected by the user, from a plurality of images. The controller 120 may also continuously detect a plurality of images that are received in real time, to generate a live streaming image content by using an image including soccer player A.

For example, if a selected object is detected from first image of a plurality of images received for a first time section after an object selection command is received, and a selected object is detected from second image of a plurality of images received for a second time section, the controller 120 may generate a live streaming image content by using the first image for the first time section and generate a live streaming image content by using the second image for the second time section. After the second time section, the controller 120 may detect an image including an object selected by the user in real time to generate a live streaming image content.

Also, if images including selected objects are multiple among a plurality of images received from the broadcasting station 50, the controller 120 may detect an image where an occupied ratio of an object is the largest, from the plurality of images including the selected objects. For example, if the first and second images of the plurality of images received from the broadcasting station 50 include objects selected by the user, a ratio of the selected object occupying the first image is 40%, and a ratio of the selected object occupying the second image is 20%, the controller 120 may detect the first image as an image including an object selected by the user.

If images including selected objects are multiple among a plurality of images received from the broadcasting station 50, the controller 120 may detect one of the plurality of images, which clearly classifies an object selected by the user, as an image including an object selected by the user. For example, if an object is soccer player B, the controller 120 may detect an image including a front, side or rear image of the soccer player B as an image including the soccer player B. The front image of the soccer player B may include a face or a number that is unique to the soccer player B, the side and rear images may include a number that is also unique to the soccer player B. In other words, any distinct feature of the object may be used to detect an image including an object selected by the user.

Through the broadcasting providing apparatus 100 as described above, the user may continuously view an image including an object selected by the user.

A broadcasting program has been described as a soccer game, and an object has been described as a soccer player in the above-described exemplary embodiment, however, the present general inventive concept is not limited thereto and may be applied to various broadcasting programs and objects. For example, if a broadcasting program is a song program, an object may be a signer, and if a broadcasting program is a car racing, an object may be a car, a driver, and etc.

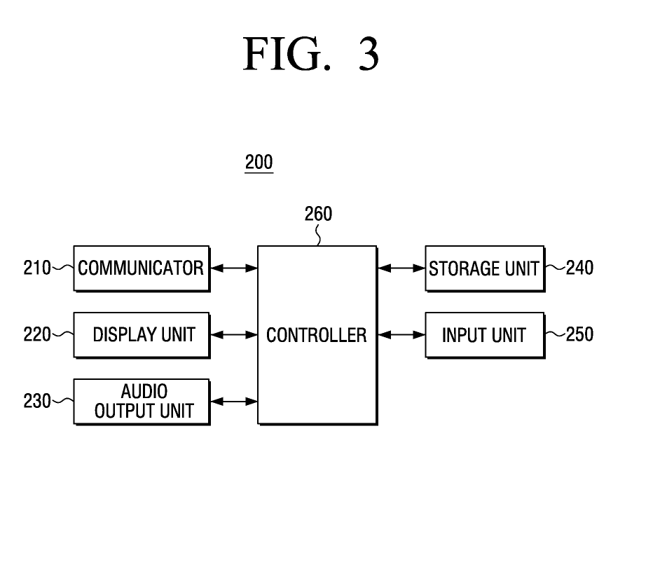

The display apparatus 200 will now be described with reference to FIG. 3. As shown in FIG. 3, the display apparatus 200 includes a communicator 210, a display unit 220, an audio output unit 230, a storage unit 240, an input unit 250, and a controller 260.

Referring to FIG. 3, the display apparatus 200 has various functions such as a content play function, a communication function, a video play function, a display function, etc., and various types of overall components of the display apparatus 200 are illustrated. Therefore, according to exemplary embodiments, some of the components of FIG. 3 may be omitted or changed or other types of components may be added.

The communicator 210 communicates with various types of external apparatuses. In particular, the communicator 210 may communicate with the external apparatus using various types of a wired and/or wireless communication method, for example, WiFi, Institute of Electrical and Electronics Engineers (IEEE), Zigbee, 3rd Generation (3G), 3rd Generation Partnership Project (3GPP), Long Term Evolution (LTE), and etc. The communicator 210 may include at least one communication chip to perform the wired and/or wireless communication method. Further, a single chip capable of performing at least one of the wired and wireless communication methods may be included in the communicator 210. For example, if the WiFi chip is used, the communicator 210 may transmit and receive various types of connection information such as an SSID, a session key, etc. and perform communication connections by using the various types of connection information to transmit and receive various types of information. The wireless communication chip refers to a chip that perform communication according to various types of communication standards such as IEEE, Zigbee, 3G, 3GPP, LTE, etc. However, the inventive concept is not limited thereto. Any communication method capable of performing the communication with the communicator 210 may be used.

In particular, the communicator 210 may transmit an object selection command, which includes information related to an object selected by the user, to the broadcasting providing apparatus 100 and receive an image content including an object selected by the user from the broadcasting providing apparatus 100.

The display unit 220 may output various types of image data under control of the controller 260. In particular, the display unit 220 may display a User Interface (UI) that is to select an object from a broadcasting program and may display at least one of the broadcasting program and an image content including the object selected by the user.

The audio output unit 230 outputs various types of audio data processed by an audio processor (not shown), various types of notification sounds, or voice messages.

The storage unit 240 stores various types of modules that are to drive the display apparatus 200. For example, the storage unit 240 may store software including a base module, a sensing module, a communication module, a presentation module, a web browser module, a service module and etc.. Here, the base module processes signals transmitted from hardware of the display apparatus 200 and transmits the processed signals to an upper layer. The sensing module collects information, and parses and manages the collected information and may include a face recognition module, a voice recognition module, a motion recognition module, a near field communication (NFC) recognition module, etc. The presentation module constitutes a display screen and may include a multimedia module that plays and outputs a multimedia content and a UI rendering module that processes a UI and a graphic. The communication module communicates with an external apparatus. The web browser module performs web browsing to access a web server. The service module includes various types of applications that are to provide various types of services.

As described above, the storage unit 240 may include various types of program modules, and some of the various types of program modules may be omitted, changed, or added according to a type and a characteristic of the display apparatus 200. For example, if the display apparatus 200 described above is realized as a tablet PC, the base module may further include a position determination module that determines a global positioning system (GPS)-based position, and the sensing module may further include a sensing module that senses a motion of the user.

The input unit 250 may receive a user command that is to control the display apparatus 200. In particular, the input unit 250 may receive a user command that is to select an object.

Here, the input unit 250 may include various types of input devices capable of controlling the display apparatus 200, such as a remote controller, a voice recognizer, a motion recognizer, a touch panel, a pointing device, etc.

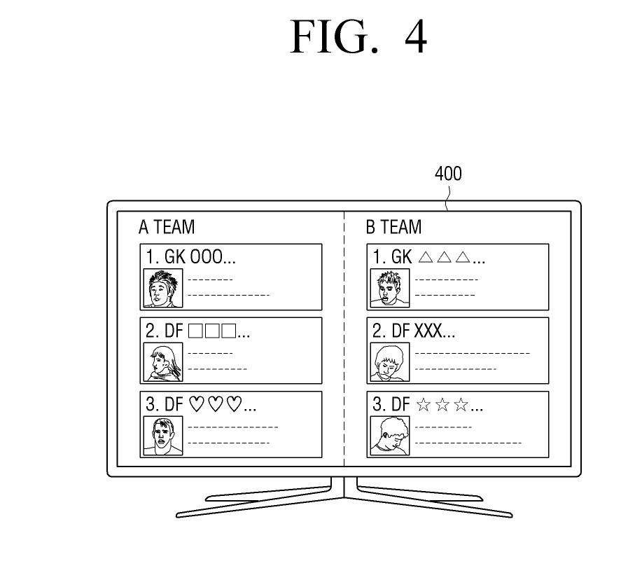

The controller 260 may control an overall operation of the display apparatus 200 according to a user command input through the input unit 250. For example, if a preset command of the user is input when a broadcasting program is displayed, the controller 260 may control the display unit 220 to display a UI that is to select an object. In detail, if the broadcasting program is a sports game, the controller 260 may control the display unit 220 to display an object selection UI 400 that may select a player an object as shown in FIG. 4. Only the object selection UI 400 is illustrated in FIG. 4, but this is only an exemplary embodiment. The object selection UI 400 may be displayed along with a general broadcasting program.

If an object is selected through the object selection UI 400, the controller 260 may control the communicator 210 to generate an object selection command including information related to the selected object and transmit the generated object selection command to the broadcasting providing apparatus 100.

If an image content including an object selected by the user is received from the broadcasting providing apparatus 100, the controller 260 may control the display unit 220 to display the received image content. Here, if the image content is a live streaming image content, the controller 260 may control the display unit 220 to display the received live streaming image content in real time.

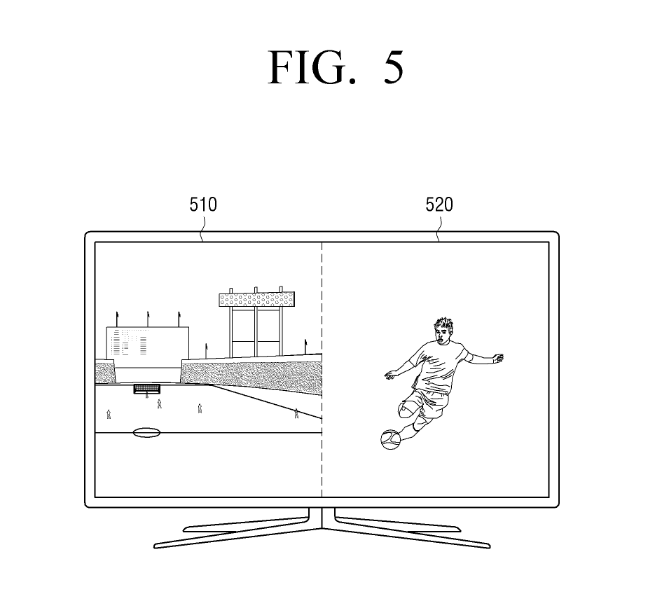

The controller 260 may also control the display unit 220 to simultaneously display an image 510 of a general broadcasting program and an image 520 including an object selected by the user on one screen as shown in FIG. 5. Therefore, the user may continuously an object selected by the user with viewing a current general broadcasting program.

However, as shown in FIG. 5, the image 510 of the general broadcasting program and the image 520 including the object selected by the user are simultaneously on the one screen, the inventive concept is not limited thereto. For example, only the image 520 including the object selected by the user may be displayed on the display unit 220 through setting of the user. Further, the image 510 of the general broadcasting program may be displayed on a full screen in the display unit 220 and the image 520 including the selected object may be displayed on a portion of the full screen in the display unit 220. Here, the image 510 of the general broadcasting program and the image 520 including the selected object may be switchable in the display unit 220 so that the image 520 including the selected object may be displayed on a full screen in the display unit 220 and the image 510 of the general broadcasting may be displayed on a portion of the full screen in the display unit 220. Even further, although only two images 510 and 520 are shown in FIG. 5 as a non-limiting example, at least one image of the general broadcasting program and/or at least one image including an object may be displayed. For example, four images including three different objects and the general broadcasting program may be shown in the display unit 220 at the same time.

The user may select a desired object and continuously view an image including the selected object through the display apparatus 200 as described above.

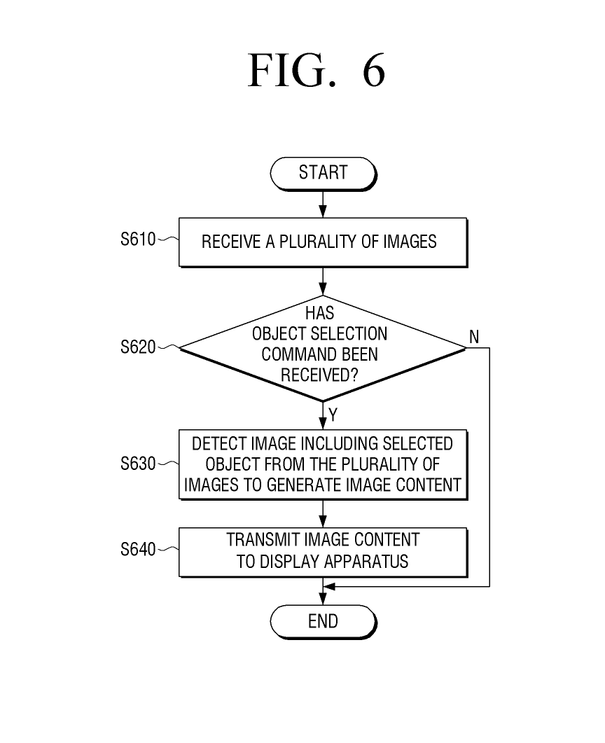

FIG. 6 is a flowchart illustrating a method of providing a broadcasting of the broadcasting apparatus 100 according to an exemplary embodiment of the present general inventive concept.

In operation S610, the broadcasting providing apparatus 100 receives a plurality of images from a broadcasting station 50. Here, the plurality of images may be images that are acquired by capturing a broadcasting program through a plurality of cameras.

In operation S620, the broadcasting providing apparatus 100 determines whether an object selection command has been received from the display apparatus 200. Here, the object selection command may include information related to an object selected by a user.

If it is determined in operation S620 that the object selection command has been received, the broadcasting providing apparatus 100 detects an image including the selected object from the plurality of images to generate an image content in operation S630. For example, the broadcasting providing apparatus 100 may detect an image including the object selected by the user from a plurality of received images and generate a streaming image content by using the detected image. Further, the broadcasting providing apparatus 100 may detect an image including the object selected by the user from a plurality of real-time received images in real time and generate a live streaming image content by using the detected image. For example, if a broadcasting program is a sports game, an object may be a sports player who plays the sports game, and the broadcasting providing apparatus 100 may detect an image including the sports player selected by the user by using a unique feature of the sports player such as a face, a uniform, a player's number, or the like of the sports player.

In operation S640, the broadcasting providing apparatus 100 transmits the generated image content to the display apparatus 200. In particular, the broadcasting providing apparatus 100 may transmit a streaming image content or a live streaming image content to the display apparatus 200 in real time.

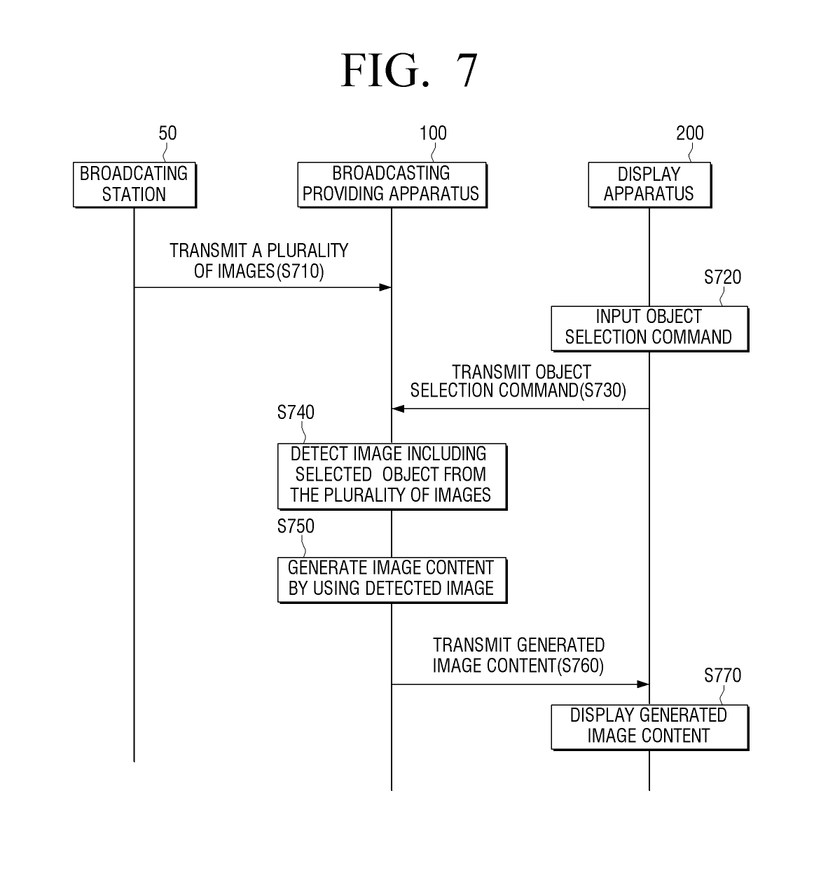

FIG. 7 is a flowchart illustrating a method of providing a broadcasting of the broadcasting providing system 10 according to an exemplary embodiment of the present general inventive concept.

In operation S710, the broadcasting station 50 transmits a plurality of images to the broadcasting providing apparatus 100. Here, the broadcasting station 50 may transmit a plurality of images, which are acquired by capturing a broadcasting program through a plurality of cameras, to the broadcasting providing apparatus 100.

In operation S720, the display apparatus 200 receives an object selection command. Here, the display apparatus 200 may receive the object selection command through the object selection UI 400 as shown in FIG. 4.

In operation S730, the display apparatus 200 transmits the object selection command to the broadcasting providing apparatus 100. Here, the object selection command may include information related to an object selected by a user.

In operation S740, the broadcasting providing apparatus 100 detects an image including the selected object from the plurality of images received from the broadcasting station 50. For example, the broadcasting providing apparatus 100 may detect a first image including an object selected by the user from a plurality of images for a first time section after the object selection command is received and detect a second image including an object selected by the user from the plurality of images for a second time section.

In operation S750, the broadcasting providing apparatus 100 generates an image content by using the detected image. For example, the broadcasting providing apparatus 100 may generate an image content by using first and second images including objects. Here, the broadcasting providing apparatus 100 may generate a steaming image content or a live streaming image content by using image data including objects.

In operation S760, the broadcasting providing apparatus 100 transmits the generated image content to the display apparatus 200. Here, the broadcasting providing apparatus 100 may stream the streaming image content or the live streaming image content in real time.

In operation S770, the display apparatus 200 displays the image content received from the broadcasting providing apparatus 100. Here, the display apparatus 200 may display a streaming image content or a live streaming image content including an object selected by the user in real time. The display apparatus 200 may simultaneously display the image 510 of the general broadcasting program and the image 520 including the object selected by the user as shown in FIG. 5.

According to a broadcasting providing method as described above, a user may view a general broadcasting program and an image including an object selected by the user in real time.

Broadcasting providing methods according to the above-described various exemplary embodiments may be realized as a program and then provided to a display apparatus. The above-described embodiments or methods may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD ROM disks, DVDs and Blu-rays; magneto-optical media such as optical discs; and hardware devices that are specially configured to store and perform program instructions, such as read-only memory (ROM), random access memory (RAM), flash memory, and the like. The computer-readable media may also be a distributed network, so that the program instructions are stored and executed in a distributed fashion. The program instructions may be executed by one or more processors. The computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

The foregoing exemplary embodiments and advantages are merely exemplary and are not to be construed as limiting. The present teaching may be readily applied to other types of apparatuses. Also, the description of exemplary embodiments is intended to be illustrative, and not to limit the scope of the claims, and many alternatives, modifications, and variations will be apparent to those skilled in the art.

What is claimed is:

1. A method of providing broadcasting of a broadcasting providing apparatus, the method comprising:
receiving a plurality of images of at least one broadcasting program from a broadcasting source and information related to an object selected by a user; and transmitting at least one image related to the selected object to a display apparatus.

2. The method of claim 1, further comprising detecting the at least one image related to the selected object from the plurality of images based on the received information.

3. The method of claim 2, further comprising generating an image content based on the at least one detected image and transmitting the generated image content to the display apparatus.

4. The method of claim 2, further comprising generating an image content based on the received information and transmitting the generated image content to the display apparatus.

5. The method of claim 1, further comprising when the information related to the selected object is received while the plurality of images are received in real time, detecting the at least one image related to the selected object from the plurality of images in real time using the received information; and
generating a live streaming image content based on the at least one detected image in real time.

6. The method of claim 5, wherein when a first image related to the selected object is detected from the plurality of images for a first time section after the information related to the selected object is received, and a second image related to the selected object is detected from the plurality of images for a second time section after the first time section, the live streaming image content is generated for the first time section by using the first image, and the live streaming image content is generated for the second time section by using the second image.

7. The method of claim 5, wherein when the at least one broadcasting program includes a plurality of images related to the selected object, an image related to the selected object with an occupying ratio of the object is the largest is detected from the plurality of images related to the selected object.

8. The method of claim 5, wherein when the at least one broadcasting program is a sports broadcasting program, the object is a sports player included in the sports broadcasting program.

9. The method of claim 8, wherein an image related to the sports player is detected by using at least one of a face, a uniform, and a player's number of the sports player.

10. A broadcasting providing apparatus comprising:
a communicator to receive a plurality of images of at least one broadcasting program from a broadcasting source and information related to an object selected by a user; and
a controller to transmit at least one image related to the selected object to a display apparatus.

11. The broadcasting providing apparatus of claim 10, wherein the controller to detect the at least one image related to the selected object from the plurality of images based on the received information.

12. The broadcasting providing apparatus of claim 11, wherein the controller to generate an image content based on the at least one detected image and to transmit the generated image content to the display apparatus.

13. The method of claim 10, wherein the controller to generate an image content based on the received information and to transmit the generated image content to the display apparatus.

14. The broadcasting providing apparatus of claim 10, when the information related to the selected object is received while the plurality of images are received from a broadcasting source, the controller detects at least one image related to the selected object from the plurality of images in real time and generates a live streaming image content based on the at least one detected image in real time.

15. The broadcasting providing apparatus of claim 14, wherein when a first image related to the selected object is detected from the plurality of images for a first time section after the information related to the selected object is received, and a second image related to the selected object is detected from the plurality of images for a second time section after the first time section, the controller generates the live streaming image content for the first time section by using the first image and generates the live streaming image content for the second time section by using the second image.

16. The broadcasting providing apparatus of claim 14, wherein when the at least one broadcasting program includes a plurality of images related to the selected object, the controller detects an image related to the selected object with an occupying ratio is the largest, from the plurality of images related to the selected object.

17. The broadcasting providing apparatus of claim 14, wherein when the broadcasting program is a sports broadcasting program, the object is a sports player included in the sports broadcasting program.

18. The broadcasting providing apparatus of claim 17, wherein the controller detects an image related to the sports player by using at least one of a face, a uniform, and a player's number of the sports player.

19. A method of providing broadcasting of a broadcasting providing system, the method comprising:
receiving a plurality of images of at least one broadcasting program from a broadcasting source and information related to an object selected by a user in a broadcasting providing apparatus;
transmitting at least one image related to the selected object in the plurality of images from the broadcasting providing apparatus to a display apparatus; and displaying the at least one transmitted image in the display apparatus.
